(19) United States
(12) Patent Application Publication
(10) Pub. No.: US 2026/0056765 A1
(43) Pub. Date: Feb. 26, 2026

(54) SYSTEM-ON-CHIP FOR PROVIDING VIRTUALIZATION ENVIRONMENT AND ELECTRONIC DEVICE INCLUDING THE SAME

(71) Applicant: SAMSUNG ELECTRONICS CO., LTD, Suwon-si (KR)

(72) Inventors: Jungtae KIM, Suwon-si (KR); Keunyoung PARK, Suwon-si (KR); Dongjin PARK, Suwon-si (KR); Hyeyeon CHUNG, Suwon-si (KR)

(73) Assignee: SAMSUNG ELECTRONICS CO, LTD., Suwon-si (KR)

(21) Appl. No.: 19/199,827

(22) Filed: May 6, 2025

(30) Foreign Application Priority Data
Aug. 26, 2024 (KR) 10-2024-0114493

(51) Int. Cl. G06F 9/455; H04L 9/08

(52) U.S. Cl. CPC G06F 9/45558; H04L 9/0822; H04L 9/0894; G06F 2009/45583; G06F 2009/45587

(57) ABSTRACT

A system-on-chip is provided. The system-on-chip includes: a storage host controller including a virtual machine identifier register and a buffer, wherein the virtual machine identifier register is configured to store an operating virtual machine identifier of an operating virtual machine that is currently running among a plurality of virtual machines and the buffer is configured to store a message queue including a command generated by the operating virtual machine; and a storage encryption controller configured to store a plurality of encrypted storage keys respectively assigned to a plurality of virtual machine identifiers of the plurality of virtual machines, select a first encrypted storage key from among the plurality of encrypted storage keys based on the operating virtual machine identifier stored in the virtual machine identifier register according to the command in the message queue, and encrypt or decrypt data corresponding to the command based on the first encrypted storage key.

### CROSS-REFERENCE TO RELATED APPLICATION

This application claims priority to Korean Patent Application No. 10-2024-0114493, filed on Aug. 26, 2024, in the Korean Intellectual Property Office, the disclosure of which is incorporated by reference herein in its entirety.

### BACKGROUND

The present disclosure relates to a system-on-chip, and more particularly, to a system-on-chip for providing a virtualization environment.

As demand for virtualization-based security services in mobile environments increases, the need for a technology to safely store data used by virtual machines in storage devices increases.

In this regard, there is an increasing requirement to isolate data storage areas for each virtual machine and ensure confidentiality of data.

### SUMMARY

One or more embodiments provide a system-on-chip capable of separating a storage area accessible to each virtual machine and assigning a different storage key to each virtual machine.

According to an aspect of an embodiment, a storage host controller including a virtual machine identifier register and a buffer, wherein the virtual machine identifier register is configured to store an operating virtual machine identifier of an operating virtual machine that is currently running among a plurality of virtual machines and the buffer is configured to store a command generated by the operating virtual machine; and a storage encryption controller configured to store a plurality of encrypted storage keys respectively assigned to a plurality of virtual machine identifiers of the plurality of virtual machines, select a first encrypted storage key from among the plurality of encrypted storage keys based on the operating virtual machine identifier stored in the virtual machine identifier register according to the command, and encrypt or decrypt data corresponding to the command based on the first encrypted storage key.

According to another aspect of an embodiment, a method of controlling access to a storage device in a virtualization environment including a plurality of virtual machines and a hypervisor, is provided. The method includes: generating, by the hypervisor, a plurality of storage KEKs respectively corresponding to virtual machine identifiers of the plurality of virtual machines; generating, by the hypervisor, a plurality of encrypted storage keys respectively corresponding to the virtual machine identifiers; obtaining a first storage KEK from among the plurality of storage KEKs based on a first virtual machine identifier, among the virtual machine identifiers, of a first virtual machine among the plurality of virtual machines; obtaining a first encrypted storage key from among the plurality of encrypted storage keys based on the first virtual machine identifier; decrypting the first encrypted storage key based on the first storage KEK to obtain a first storage key; and encrypting or decrypting data related to a command generated by the first virtual machine based on the first storage key.

According to another aspect of an embodiment, the method comprises extracting the slot identifier based on the command, identifying the storage key slot based on the first virtual machine identifier and the slot identifier; and obtaining the first encrypted storage key from the storage key slot.

According to another aspect of an embodiment, an electronic device includes: a memory including volatile memory cells; a storage device including nonvolatile memory cells; and a system-on-chip configured to: store a plurality of encrypted storage keys respectively assigned to a plurality of virtual machine identifiers of a plurality of virtual machines; store a plurality of storage KEKs assigned to the plurality of virtual machine identifiers; select a first encrypted storage key from among the plurality of encrypted storage keys based on a first virtual machine identifier of a first virtual machine according to a command generated by the first virtual machine from among the plurality of virtual machines; select a first storage KEK from among the plurality of storage KEKs based on the first virtual machine identifier; decrypt the first encrypted storage key based on the first storage KEK to obtain a storage key; read data related to the command from the memory based on the command being a write command, encrypt the read data, based on the storage key; and store the encrypted data in the storage device.

According to another aspect of an embodiment, the system-on-chip is further configured to, based on the command being a read command, read data related to the command from the storage device, decrypt the read data, based on the storage key, and store the decrypted data in the memory.

According to another aspect of an embodiment, the command comprises the first virtual machine identifier and a key slot identifier, and the system-on-chip is further configured to select a first key slot of the plurality of key slots, based on the first virtual machine identifier and the key slot identifier provided in the command, and select an encrypted storage key stored in the selected key slot as the first encrypted storage key.

### BRIEF DESCRIPTION OF DRAWINGS

The above and other aspects and features will be more apparent from the following description of embodiments, taken in conjunction with the accompanying drawings, in which:

FIG. 1 is a block diagram showing an electronic device according to an embodiment;

FIG. 2 is a block diagram illustrating a virtualization system according to an embodiment;

FIG. 3 is a block diagram illustrating a virtualization system according to an embodiment;

FIG. 4 is a drawing illustrating a storage key slot according to an embodiment;

FIG. 5 is a diagram illustrating a storage key encryption key (KEK) table according to an embodiment;

FIG. 6 is a block diagram illustrating storage protection setting operations and storage input/output operations according to an embodiment;

FIG. 7 is a drawing describing an access control table according to an embodiment;

FIG. 8 is a block diagram illustrating a storage key generation operation according to an embodiment;

FIG. 9 is a block diagram illustrating a storage KEK table update operation according to an embodiment;

FIG. 10 is a block diagram illustrating storage input/output operations according to an embodiment;

FIG. 11 is a flowchart for explaining an operation method of the encryption controller according to an embodiment; and

FIG. 12 is a flowchart illustrating a method for controlling access to a storage device in a virtualization environment according to an embodiment.

### DETAILED DESCRIPTION

Hereinafter, embodiments are described in detail with reference to the attached drawings. Like components are denoted by like reference numerals throughout the specification, and repeated descriptions thereof are omitted. It will be understood that when an element or layer is referred to as being “on,” “connected to” or “coupled to” another element or layer, it can be directly on, connected or coupled to the other element or layer, or intervening elements or layers may be present. By contrast, when an element is referred to as being “directly on,” “directly connected to” or “directly coupled to” another element or layer, there are no intervening elements or layers present. Embodiments described herein are example embodiments, and thus, the present disclosure is not limited thereto, and may be realized in various other forms. Each embodiment provided in the following description is not excluded from being associated with one or more features of another example or another embodiment also provided herein or not provided herein but consistent with the present disclosure.

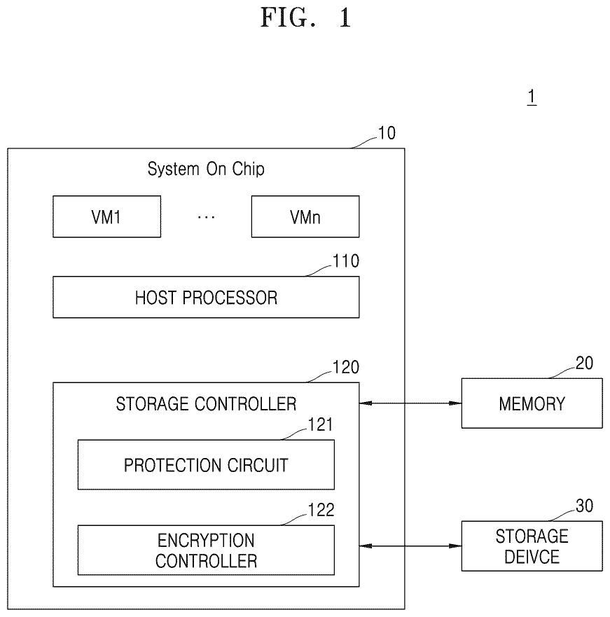

FIG. 1 is a block diagram showing an electronic device according to an embodiment.

Referring to FIG. 1, an electronic device 1 may include a system-on-chip (SoC) 10, a memory 20, and a storage device 30.

The SoC 10 may be connected to components of the electronic device 1 and perform operations or data processing related to control and/or communication of each component. The SoC 10 may be referred to as a host device.

The memory 20 may include volatile memory. For example, the memory 20 may include dynamic random-access memory (DRAM), static random-access memory (SRAM), magnetic random access memory (MRAM), etc. However, embodiments are not limited thereto, and the memory 20 may include non-volatile memory. or both volatile memory and non-volatile memory

The storage device 30 may include non-volatile memory. For example, the storage device 30 may include NAND flash memory, NOR flash memory, resistive random-access memory, phase-change memory, magnetoresistive random access memory, etc.

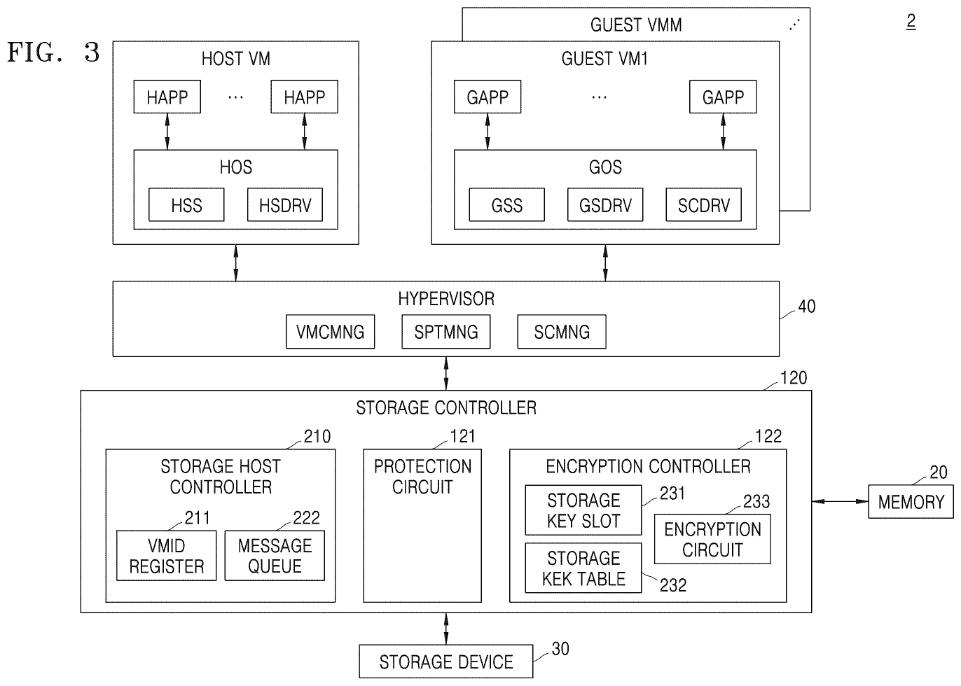

The SoC 10 may include a host processor 110 and a storage controller 120. The host processor 110 may control the operation of the SoC 10. The host processor 110 may manage requests from various applications, software, or virtual machines VM1 to VMn running on the SoC 10. The SoC 10 may transmit a write command to store data to the memory 20 or the storage device 30 through the storage controller 120. The SoC 10 may transmit a read command to read data from the memory 20 or storage device 30 through the storage controller 120. For example, the storage controller 120 may include a memory controller that controls access to the memory 20. The storage controller 120 may include a storage host controller (e.g., 210 of FIG. 3) that controls access to the storage device 30.

During storage input/output operations, the SoC 10 may encrypt or decrypt data. For example, during a storage write operation, the SoC 10 may read data loaded into the memory 20, encrypt the read data, and store the encrypted data in the storage device 30. For example, during a storage read operation, the SoC 10 may read encrypted data stored in the storage device 30, decrypt the read encrypted data, and store the decrypted data in the memory 20.

The storage controller 120 may include a protection circuit 121 and an encryption controller 122.

The protection circuit 121 may manage storage areas allocated to virtual machines VM1 to VMn. The protection circuit 121 may allow or block access of the virtual machines VM1 to VMn so that each virtual machine VM1 to VMn may access only the allocated storage areas. The protection circuit 121 may manage storage areas allocated to virtual machines VM1 to VMn. In detail, the protection circuit 121 may dynamically map the storage areas of the storage device 30 that may be accessed by the virtual machines VM1 to VMn with virtual machine identifiers of the virtual machines VM1 to VMn. For example, the protection circuit 121 may dynamically manage the mapping relationship between the virtual machine identifier and the storage areas of the storage device 30 by generating and updating an access control table (e.g., ACT of FIG. 7). The protection circuit 121 may commonly map two or more virtual machines VM1 to VMn to a storage area (i.e., the same storage area) of the storage areas of the storage device 30. The storage controller 120 may store data in a storage area of a storage device 30 permitted by the control of the protection circuit 121, or read data from a storage area of a storage device 30 permitted by the control of the protection circuit 121. According to an embodiment, because the virtual machines VM1 to VMn may share some storage areas of the storage device 30, efficient use of the storage device 30 may be enabled. Furthermore, because the storage areas allocated to the virtual machines VM1 to VMn are distinguished from each other through virtual machine identifiers, confidentiality of the data of the virtual machines VM1 to VMn may be provided.

The encryption controller 122 may encrypt or decrypt data during storage input/output operations. For example, when a storage write operation is performed, data of the virtual machines VM1 to VMn loaded into the memory 20 may be encrypted. During the storage write operation, the encrypted data may be stored in the storage device 30. For example, the encryption controller 122 may decrypt encrypted data stored in the storage device 30 during a storage read operation. During the storage read operation, the decrypted data may be loaded into the memory 20.

The encryption controller 122 may store multiple storage keys assigned to the virtual machines VM1 to VMn. The encryption controller 122 may select a storage key based on the virtual machine identifier. The encryption controller 122 may encrypt data read from the memory 20 based on the selected storage key during the storage write operation. The encryption controller 122 may decrypt encrypted data read from the storage device 30 based on the selected storage key during the storage read operation.

In some embodiments, the encryption controller 122 may store multiple encrypted storage keys assigned to the virtual machines VM1 to VMn. For example, the encryption controller 122 may store at least one encrypted storage key corresponding to a virtual machine identifier in a storage key slot (231 of FIG. 3).

The encryption controller 122 may store a plurality of key encryption keys (KEKs) assigned to the virtual machines VM1 to VMn. For example, the encryption controller 122 may store the KEK corresponding to a virtual machine identifier in a storage KEK table (232 in FIG. 3). The encryption controller 122 may obtain the storage key by selecting the KEK and the encrypted storage key, based on the virtual machine identifier and decrypting the encrypted storage key based on the KEK.

The encryption controller 122 may encrypt data read from the memory 20 based on the obtained storage key during the storage write operation. The encryption controller 122 may decrypt the encrypted data read from the storage device 30 based on the obtained storage key during the storage read operation.

According to an embodiment, because the encrypted data is stored in the storage device 30, data may be safely stored in the storage device 30. Furthermore, because different storage keys are assigned to the virtual machines VM1 to VMn, confidentiality of the data of the virtual machines VM1 to VMn may be provided.

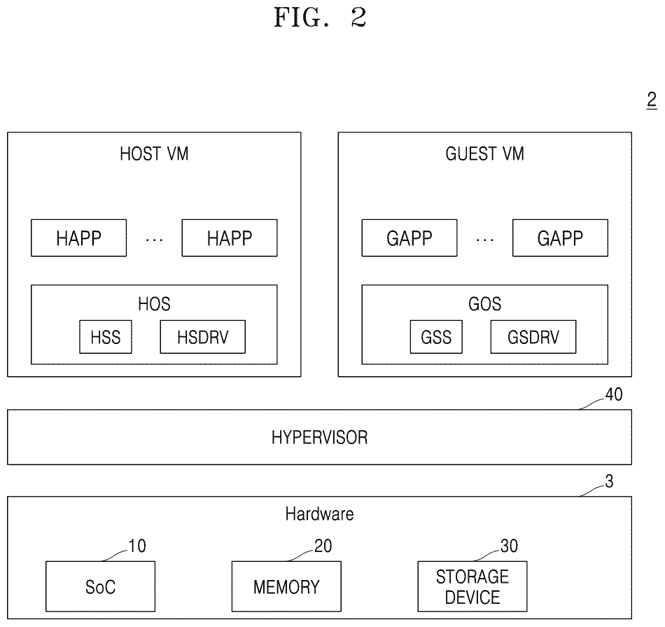

FIG. 2 is a block diagram illustrating a virtualization system according to an embodiment.

Referring to FIG. 2, a virtualization system 2 may include host applications HAPPs, a host operating system HOS, guest applications GAPPs, a guest operating system GOS, a hypervisor 40, and hardware 3. The hardware 3 may correspond to the electronic device 1 of FIG. 1 and may include a SoC 10, a memory 20, and a storage device 30.

However, embodiments are not limited thereto, and the hardware 3 may include various physical hardware devices such as a camera, a graphics processing unit (GPU), a neural processing unit (NPU), a peripheral component interconnect express (PCIe) device, a universal flash storage (UFS) device, etc.

The SoC 10 may provide a function for implementing the virtualization environment. The host applications HAPP, host operating system HOS, guest applications GAPP, guest operating system GOS, and hypervisor 40 may run in the virtualization environment. For example, the host operating system HOS may run on the host virtual machine HOST VM in the virtualization environment. The guest operating system GOS may run on the guest virtual machine GUEST VM in the virtualization environment and may run independently of the host operating system HOS. The host applications HAPPs may run on the host operating system HOS. The guest applications GAAPs can run on a guest operating system (GOS). The hypervisor 40 may implement the virtualization environment by utilizing the function of the hardware 3 and generate and control a host virtual machine HOST VM and a guest virtual machine GUEST VM in the virtualization environment.

In FIG. 2, only one guest virtual machine GUEST VM is illustrated, but embodiments are not limited thereto, and the number of guest virtual machines GUEST VM operating on the hypervisor 40 may be determined in various ways depending on the virtualization environment.

The host operating system HOS may include a host storage service HSS and a host storage driver HSDRV. The host storage service HSS may manage logical block addresses of storage areas of a storage device 30. The host storage service HSS may allocate storage areas of a storage device 30 to the guest virtual machine GUEST VM. In detail, the host storage services HSS may assign logical block addresses to the guest virtual machine GUEST VM. The hosted storage service HSS may include a file system. For example, the host storage service HSS may include at least one of various file system formats, such as file allocation table (FAT), FAT32, new technology file system (NTFS), hierarchical file system (HFS), journaled file system2 (JSF2), extended file system (XFS), on-disk structure-5 (ODS-5), universal disk format (UDF), zettabyte file system (ZFS), unix file system (UFS), second extended file system (ext2), third extended file system (ext3), fourth extended file system (ext4), Reiser file system (ReiserFS), reiser4, international organization for standardization 9660 (ISO 9660), gnome virtual file system (gnome VFS), BFS, windows future storage (WinFS), etc. The host storage driver HSDRV may write data to or read data from the storage device 30 by controlling the SoC 10 in response to a request from a host application HAPP transmitted through the host storage service HSS.

The guest operating system GOS may include a guest storage service GSS and a guest storage driver GSDRV. The guest storage service GSS may manage logical block addresses of storage areas allocated by host storage service HSS. The guest storage service GSS may contain a file system. The guest storage driver GSDRV may control the SoC 10 to write data to the storage device 30 or read data from the storage device 30, in response to a request from a guest application GAPP delivered through the guest storage service GSS.

In FIG. 2, the host applications HAPPs, host operating system HOS, guest applications GAPPs, guest operating system GOS, and hypervisor 40 may be loaded into the memory 20 as software programs and executed by the SoC 10.

In detail, the memory 20 stores data and program codes, and software programs such as host applications HAPP, host operating system HOS, guest applications GAPP, guest operating system GOS, and hypervisor 40 for implementing the virtualization environment may be loaded into the memory 20. The storage device 30 may store the host applications HAPPs, host operating system HOS, guest applications GAPPs, guest operating system GOS, and hypervisor 40. For example, when booting the virtualization system 2, the software program stored in the storage device 30 is loaded into the memory 20 based on the boot sequence, and the SoC 10 may provide the virtualization environment based on the software program loaded into the memory 20. In this way, the memory 20 may function as the working memory of the virtualization system 2.

The hardware 3 may be controlled by the host operating system HOS, the guest operating system GOS, and the hypervisor 40. The hypervisor 40 may generate, schedule, and manage virtual machines. The hypervisor 40 provides an interface between the virtual machines and hardware 3 and may manage the execution of instructions and data transfer associated with the virtual machines. The hypervisor 40 may also be referred to as a virtual machine monitor or a virtual machine manager.

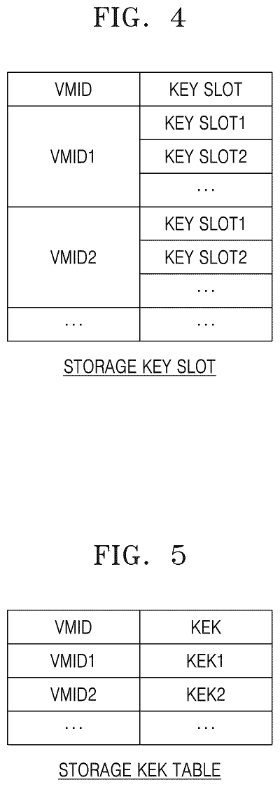

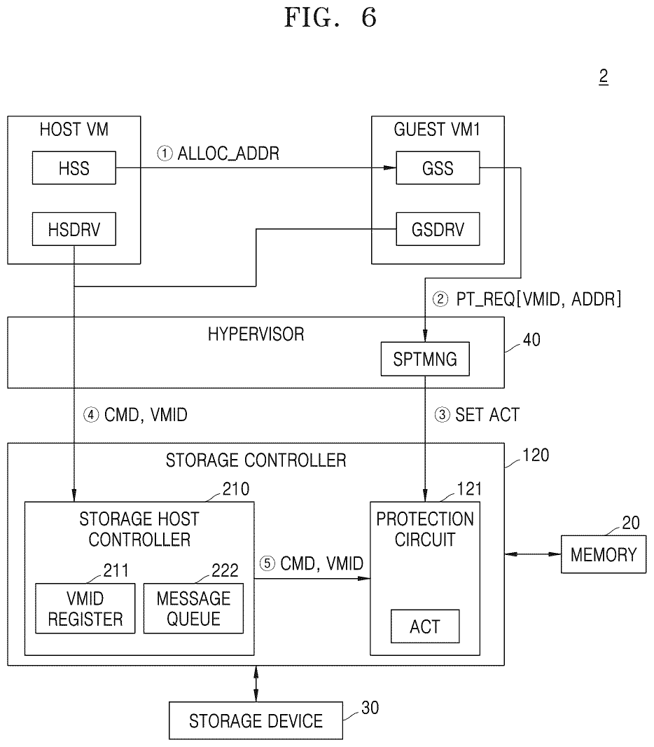

FIG. 3 is a block diagram illustrating a virtualization system according to an embodiment. FIG. 4 is a drawing illustrating a storage key slot according to an embodiment. FIG. 5 is a diagram illustrating a storage KEK table according to an embodiment.

Referring to FIG. 3, the virtualization system 2 may include a host virtual machine HOST VM, a plurality of guest virtual machines VM1 to VMn, a hypervisor 40, a storage controller 120, memory 20, and a storage device 30. Among the guest virtual machines VM1 to VMn, the guest virtual machine VM1 is described below, but the description of the guest virtual machine VM1 may also be applied to other guest virtual machines VM2 to VMn.

The guest virtual machine VM1 may include a guest storage service GSS, a guest storage driver GSDRV, and a storage encryption driver SCDRV.

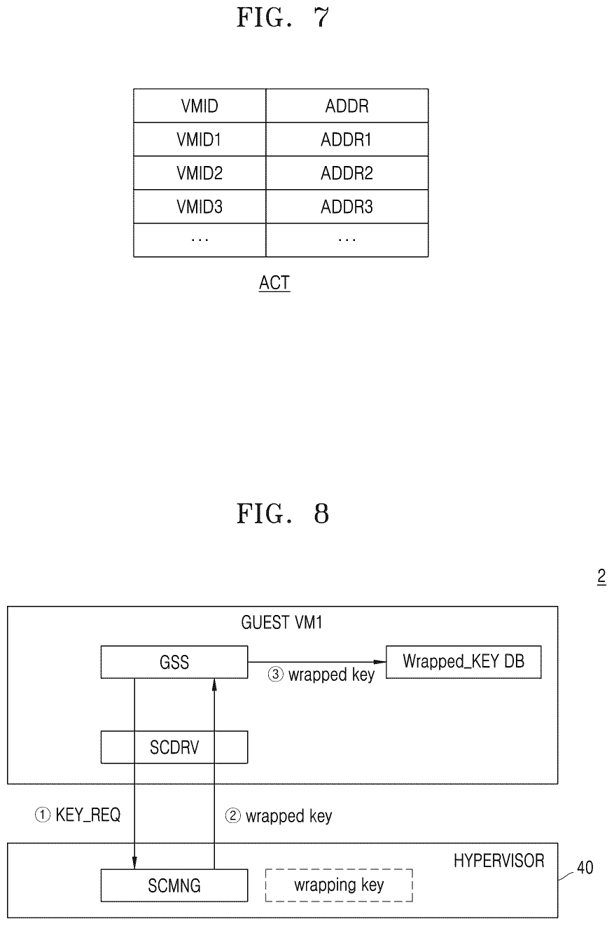

The guest storage service GSS may provide protection requests (e.g., PT_REQ in FIG. 6) for allocated storage areas to the hypervisor 40. In addition, when a storage key generation operation is performed, the guest storage service GSS may provide a storage key generation request (e.g., KEY_REQ in FIG. 8) to the storage encryption driver SCDRV to encrypt the allocated storage areas, and receive and store a wrapped key

The storage encryption driver SCDRV may manage storage keys used to encrypt data stored in storage areas of a storage device 30. In detail, when the storage key generation operation is performed, the storage encryption driver SCDRV provides the storage key generation request (e.g., KEY_REQ of FIG. 8) to the storage encryption manager SCMNG of the hypervisor 40, may receive a wrapped key and provide the received wrapped key to the guest storage service GSS. In addition, when a storage key slot update operation is performed, upon receiving a slot ID request (e.g., SLOTID_REQ of FIG. 10) from the guest storage driver GSDRV, the storage encryption driver SCDRV may store the storage key in the storage key slot 231 within the encryption controller 230 and provide the slot ID that distinguishes the key slot to the guest storage driver GSDRV.

When the storage key slot update operation is performed, upon receiving a request from a guest application GAPP, the guest storage driver GSDRV may provide a slot ID request (e.g., SLOTID_REQ in FIG. 10) to the storage encryption driver SCDRV and receive a slot ID from the storage encryption driver SCDRV. The guest storage driver GSDRV may generate a command that includes a slot ID (e.g., CMD[SLOTID] in FIG. 10).

The hypervisor 40 may include a VM context manager VMCMNG, a storage protection manager SPMNG, and a storage encryption manager SCMNG.

When context switching occurs between virtual machines, the VM context manager VMCMNG may store a virtual machine identifier VMID for the running virtual machine in the VMID register 211.

On receiving a protection request for storage areas (e.g., PT_REQ in FIG. 6), the storage protection manager SPMNG may identify storage areas that the virtual machine may access and control the protection circuit 121 to limit the storage areas of the storage device 30 that the virtual machine may access. For example, the storage protection manager SPMNG may control the protection circuit 121 to generate or update an access control table (ACT in FIG. 7).

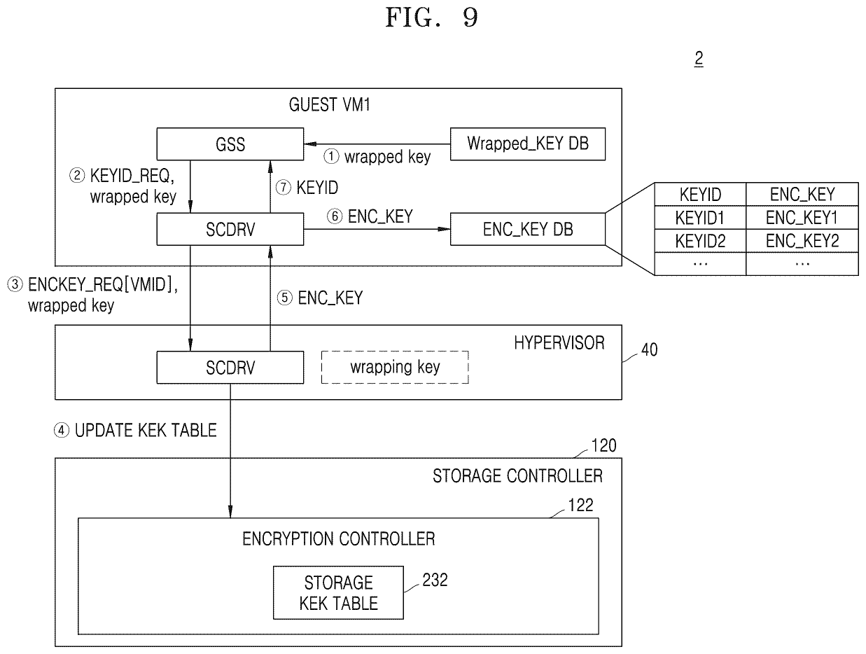

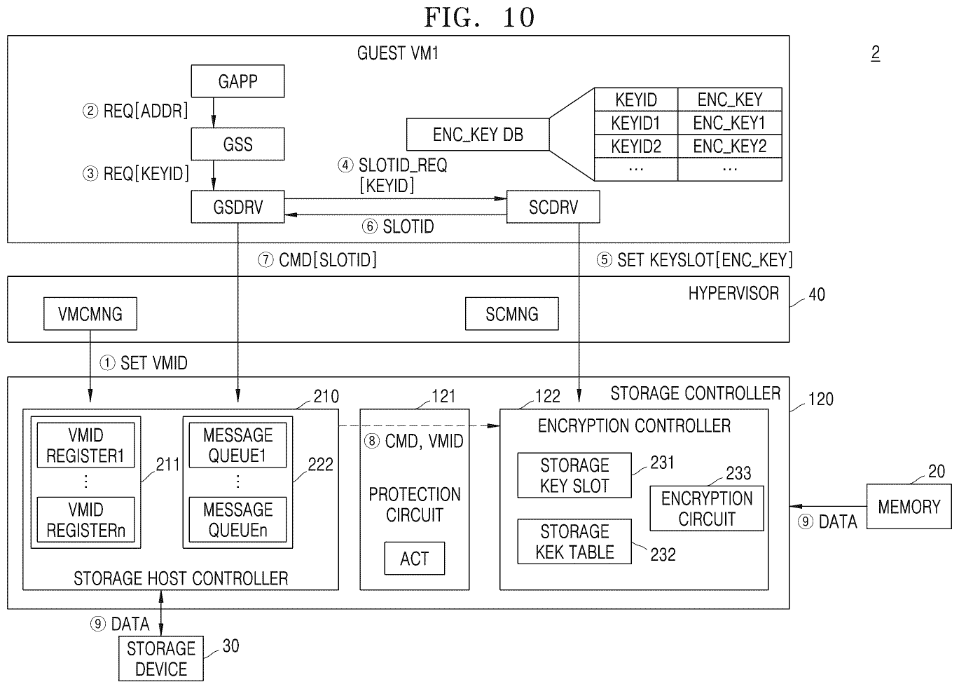

The storage encryption manager SCMNG may generate storage keys corresponding to a plurality of virtual machines. In detail, when a storage key generation operation is performed, on receiving a storage key generation request (e.g., KEY_REQ in FIG. 8) from the storage encryption driver (SCDRV), the storage encryption manager (SCMNG) may identify the virtual machine identifier of the virtual machine that generated the request and generate a storage key corresponding to the virtual machine. The storage encryption manager SCMNG may encrypt the storage key based on a wrapping key to generate the wrapped key and provide the wrapped key to the storage encryption driver SCDRV. Therefore, data confidentiality may be provided because the decrypted storage key is not exposed to the virtual machine. In addition, when a storage KEK table update operation is performed, on receiving a storage key encryption request (e.g., ENKEY_REQ in FIG. 9) from the storage encryption driver SCDRV, the storage encryption manager SCMNG may generate a storage key encryption key and encrypt the storage key using the storage key encryption key. The storage encryption manager SCMNG may provide an encrypted storage key to the storage encryption driver SCDRV and store the storage KEK in a storage KEK table 232.

The storage controller 120 may include a storage host controller 210, a protection circuit 121, and an encryption controller 122.

The storage host controller 210 may access the storage device 30 by providing write requests and read requests to the storage device 30. The storage host controller 210 may include a VMID register 211 and a message queue 222. The number of VMID registers 211 and message queues 222 is not limited thereto. The VMID register 211 may store the virtual machine identifier VMID of the virtual machine. When a context switch occurs between virtual machines, a virtual machine identifier for the virtual machine running on the host processor 110 may be stored in the VMID register 211. The virtual machine identifier stored in the VMID register 211 may be used to distinguish which virtual machine a command stored in the message queue 222 is generated by. The message queue 222 may be a buffer that stores commands generated by the virtual machine.

The encryption controller 122 may include a storage key slot 231, a storage KEK table 232, and an encryption circuit 233. For example, the encryption controller 122 may include a nonvolatile memory or a volatile memory which includes the storage key slot 231 and the storage KEK table 232.

The storage key slot 231 may store a storage key used to encrypt data to be stored in the storage device 30 or to decrypt data read from the storage device 30. In some embodiments, the storage key slot 231 may store an encrypted storage key. The storage key slot 231 may be managed by the storage encryption driver SCDRV of a guest virtual machine GUEST VM1. As shown in FIG. 4, the storage key slot 231 may include at least one key slot corresponding to the virtual machine identifier VMID. For example, the storage key slot 231 may include two or more key slots corresponding to each of the virtual machine identifiers VMID1 and VMID2. Each key slot may be assigned a key slot ID. When a storage key slot update operation occurs, the storage encryption driver SCDRV may obtain a key slot ID and provide the key slot ID to the guest storage driver GSDRV. The storage key slot 231 may include a plurality of key slots corresponding to the virtual machine identifier VMID, and at least one storage key may be stored in the plurality of key slots.

The storage KEK table 232 may store a key for encrypting a storage key. The storage KEK table 232 may be managed by the storage encryption manager SCMNG included in the hypervisor 40. Therefore, data confidentiality may be provided because virtual machines may not access the storage KEK table 232. As shown in FIG. 5, the storage KEK table 232 may store a KEK corresponding to the virtual machine identifier VMID. For example, the storage KEK table 232 may store KEK1 corresponding to the virtual machine identifier VMID1 and KEK2 corresponding to the virtual machine identifier VMID2.

The encryption circuit 233 may encrypt or decrypt data based on a storage key set for each virtual machine. In detail, during a storage write operation, the encryption circuit 233 may encrypt data loaded into the memory 20 based on the storage key. The encrypted data may be stored in a storage device 30. During a storage read operation, the encryption circuit 233 may decrypt data read from the storage device 30 based on the storage key. The decrypted data may be loaded into the memory 20.

FIG. 6 is a block diagram illustrating storage protection setting operations and storage input/output operations according to an embodiment FIG. 7 is a drawing describing an access control table according to an embodiment.

Referring to FIG. 6, during the storage protection setting operation, the host storage service HSS of the host virtual machine HOST VM may assign addresses (e.g., logical block addresses) of storage areas of the storage device 30 to a guest virtual machine GUEST VM1 (\textcircled{1}).

During the storage protection setting operation, the guest storage service GSS may provide a protection request PT_REQ to a storage protection manager SPTMNG of the hypervisor 40 (\textcircled{2}). The protection request PT_REQ may include a virtual machine identifier VMID and an assigned address ADDR. For example, the assigned address ADDR provided to the storage protection manager SPTMNG may be one of the addresses assigned to the guest VM1 based on the assigned address ADDR provided by the host virtual machine HOST VM.

During the storage protection setting operation, the storage protection manager SPTMNG may control the protection circuit 121 to generate or update an access control table ACT included in the protection circuit 121 (\textcircled{3}). Referring to FIG. 7, the access control table ACT may represent a mapping relationship between the virtual machine identifier VMID and the address ADDR. However, embodiments are not limited thereto, and the access control table ACT may distinguish addresses of storage devices 30 by unit size and store bitmap information indicating storage areas of the unit size allocated to each virtual machine identifier VMID.

During a storage input/output operation, the host storage driver HSDRV or guest storage driver GSDRV may provide a command CMD corresponding to an input/output request of a host application HAPP or a guest application GAPP to the storage host controller 210 (\textcircled{4}). The command CMD may be a read command or a write command for accessing the storage device 30. The command CMD may include the address ADDR of the storage area to be accessed. The hypervisor 40 may provide the virtual machine identifier VMID to the storage host controller 210. The virtual machine identifier VMID may be stored in the VMID register 211. The command CMD may be stored in the message queue 222.

During the storage input/output operation, the protection circuit 121 may search the access control table ACT, based on the command CMD and the virtual machine identifier VMID, and determine whether to allow access to the storage device 30, based on the search result (\textcircled{5}). In detail, the protection circuit 121 extracts an address ADDR based on the command CMD, allows access when there is a mapping relationship between the virtual machine identifier VMID and the address ADDR in the access control table ACT, and blocks access when there is no mapping relationship between the virtual machine identifier VMID and the address ADDR. When the access is permitted, the storage host controller 210 may perform storage input/output operations by accessing the storage device 30, and when the access is blocked, the storage input/output operations of the storage host controller 210 may be stopped.

When the guest virtual machine GUEST VM1 does not use the assigned address, the host storage service HSS may reclaim the address, and the storage protection manager SPTMNG may delete the mapping information for the address and the virtual machine identifier from the access control table ACT. The storage protection manager SPTMNG may update new mapping information between the virtual machine and the storage address in the deleted space.

According to an embodiment, the data confidentiality of virtual machines may be provided because the storage areas allocated to virtual machines are distinguished from each other through virtual machine identifiers, the virtual machines may access only the allocated storage areas, and the data is encrypted with an encryption key allocated to the virtual machines.

FIG. 8 is a block diagram illustrating a storage key generation operation according to an embodiment.

Referring to FIG. 8, a guest storage service GSS may search a wrapped key database Wrapped_KEY DB to determine whether a wrapped key exists for a storage area that requires encryption. When there is no the wrapped key in the Wrapped_KEY DB, the guest storage service GSS may provide a storage key generation request KEY_REQ to a storage encryption manager SCMNG through a storage encryption driver SCDRV (\textcircled{1}). The storage key generation request KEY_REQ may include a virtual machine identifier VMID. The storage key generation request KEY_REQ may include an address ADDR of the storage area.

The storage encryption manager SCMNG may generate storage keys corresponding to the virtual machine identifiers VMIDs. That is, different virtual machine identifiers VMIDs may result in different storage keys being generated accordingly. In some embodiments, the storage encryption manager SCMNG may generate storage keys corresponding to the virtual machine identifier VMID and address ADDR. That is, the storage encryption manager SCMNG may generate different storage keys for different addresses ADDR even if the virtual machine identifiers VMIDs are the same. However, embodiments are not limited thereto, and the storage keys may be generated in a variety of ways.

The storage encryption manager SCMNG may generate a wrapped key by encrypting the storage key based on a wrapping key. The storage encryption manager SCMNG may provide wrapped keys to the guest storage service GSS through the storage encryption driver SCDRV (\textcircled{2}).

The guest storage service GSS may store wrapped keys in the wrapped key database Wrapped_KEY DB (\textcircled{3}).

Referring to FIG. 8, the guest virtual machine GUEST VM1 may store the storage key in the form of an encrypted wrapped key based on the wrapping key. Therefore, data confidentiality may be provided because an original storage key may not be exposed to the guest virtual machine GUEST VM1.

FIG. 9 is a block diagram illustrating a storage KEK table update operation according to an embodiment.

Referring to FIG. 9, when encryption is required for data to be stored in a storage area of a storage device 30 or decryption is required for data read from the storage area of the storage device 30, a guest storage service GSS may load a wrapped key for the corresponding storage area from a wrapped key database Wrapped_KEY DB (\textcircled{1}).

The guest storage service GSS may provide a key ID request KEYID_REQ requesting a key ID that identifies a storage key and the wrapped key to a storage encryption driver SCDRV (\textcircled{2}).

The storage encryption driver SCDRV may provide an encrypted storage key request ENCKEY_REQ and the wrapped key to a storage encryption manager SCMNG (\textcircled{3}). The encrypted storage key request ENCKEY_REQ may include a virtual machine identifier VMID.

The storage encryption manager SCMNG may obtain the storage key by decrypting the wrapped key based on a wrapping key.

The storage encryption manager SCMNG may generate a storage KEK corresponding to the virtual machine identifier VMID and encrypt the storage key based on the storage KEK. The storage encryption manager SCMNG may update the storage KEK table 232 included in the encryption controller 122 so that the storage KEK corresponding to a virtual machine identifier VMID is stored in the storage KEK table (\textcircled{4}).

The storage encryption manager SCMNG may provide an encrypted storage key ENC_KEY based on the storage KEK to the storage encryption driver SCDRV (\textcircled{5}).

The storage encryption driver SCDRV may store the encrypted storage key ENC_KEY in the encrypted storage key database ENC_KEY DB and generate the key ID that may identify the encrypted storage key ENC_KEY (\textcircled{6}).

The storage encryption driver SCDRV may provide the key ID to the guest storage service GSS (\textcircled{7}). The guest storage service GSS may manage the key IDs by mapping the key IDs to addresses of storage areas that require encryption.

FIG. 10 is a block diagram illustrating storage input/output operations according to an embodiment. As described above with reference to FIG. 6, an access control table ACT may be generated in a protection circuit 121 through a storage protection setting operation. A storage key slot update operation may also be performed while a storage I/O operation is performed.

A virtual machine context manager VMCMNG may store a virtual machine identifier VMID of the currently running virtual machine in a VMID register 211 (\textcircled{1}). The virtual machine that generated the command stored in a message queue 222 may be identified by referring to the VMID register 211. For example, a command stored in message queue 222 may be generated by the virtual machine having the virtual machine identifier VMID stored in a VMID register 211.

A guest application GAPP may provide input/output requests REQ to guest storage service GSS (\textcircled{2}). The input/output request REQ may include the address ADDR of the storage area where the data is stored.

The guest storage service GSS may provide the input/output requests REQ to the guest storage driver GSDRV (\textcircled{3}). The input/output request REQ may include a key ID associated with a storage key used to encrypt data for the storage area corresponding to the address ADDR. As described above with reference to FIG. 9, the guest storage service GSS may obtain key IDs for storage areas through a storage key generation operation.

The guest storage driver GSDRV may provide a slot ID request SLOTID_REQ to the storage encryption driver SCDRV requesting a slot ID of the key slot that stores the storage key (\textcircled{4}). For example, referring to FIG. 4, the slot ID may be assigned to each key slot. The slot ID request SLOTID_REQ may include the key ID.

The storage encryption driver SCDRV may obtain an encrypted storage key ENC_KEY corresponding to the key ID from an encrypted storage key database ENC_KEY DB and store the obtained encrypted storage key ENC_KEY in a storage key slot 231 through a storage encryption manager SCMNG (\textcircled{5}). In detail, the storage encryption driver SCDRV may update the storage key slot 231 through the storage encryption manager SCMNG so that the virtual machine identifier VMID of the guest virtual machine GUEST VM1 and the obtained encrypted storage key ENC_KEY are mapped to each other. In some embodiments, the storage encryption driver SCDRV may store the slot ID of the key slot in an encrypted storage key database ENC_KEY DB. For example, referring to FIG. 4, the storage encryption driver SCDRV may obtain the slot ID of the key slot where the encrypted storage key ENC_KEY is stored through the storage encryption manager SCMNG and store the slot ID in the encrypted storage key database ENC_KEY DB. The storage encryption manager SCMNG may provide the virtual machine identifier VMID of the guest virtual machine GUEST VM1 to an encryption controller 122.

The storage encryption driver SCDRV may provide the slot ID of the key slot in which the encrypted storage key ENC_KEY is stored in the storage key slot 231 to the guest storage driver GSDRV (\textcircled{6}).

The guest storage driver GSDRV may store a command CMD including the slot ID in the message queue 222 (\textcircled{7}). The command CMD may include an address ADDR.

The protection circuit 121 may extract the address ADDR based on the command CMD and control access based on a mapping relationship between the virtual machine identifier VMID and the address ADDR in the access control table ACT. The storage host controller 210 may provide the command CMD and the virtual machine identifier VMID to the encryption controller 122 when access to the address ADDR is permitted by the protection circuit 121 (\textcircled{8}).

The encryption controller 122 may obtain the storage key based on the command CMD and the virtual machine identifier VMID. When the command CMD is a write command, the encryption controller 122 may encrypt data read from the memory 20 based on the storage key (\textcircled{9}). The encrypted data may be stored in a storage device 30 (\textcircled{9}). Alternatively, when the command CMD is a read command, the encryption controller 122 may decrypt encrypted data read from the storage device 30 based on the storage key (\textcircled{9}). The decrypted data may be loaded into the memory 20 (\textcircled{9}). In detail, the encryption controller 122 may obtain a storage KEK from the storage KEK table 232 based on the virtual machine identifier VMID. The encryption controller 122 may obtain the encrypted storage key from the storage key slot 231 based on the slot ID included in the command CMD. The encryption controller 122 may obtain the storage key by decrypting the encrypted storage key based on the storage KEK. The encryption circuit 233 may encrypt or decrypt data based on the storage key.

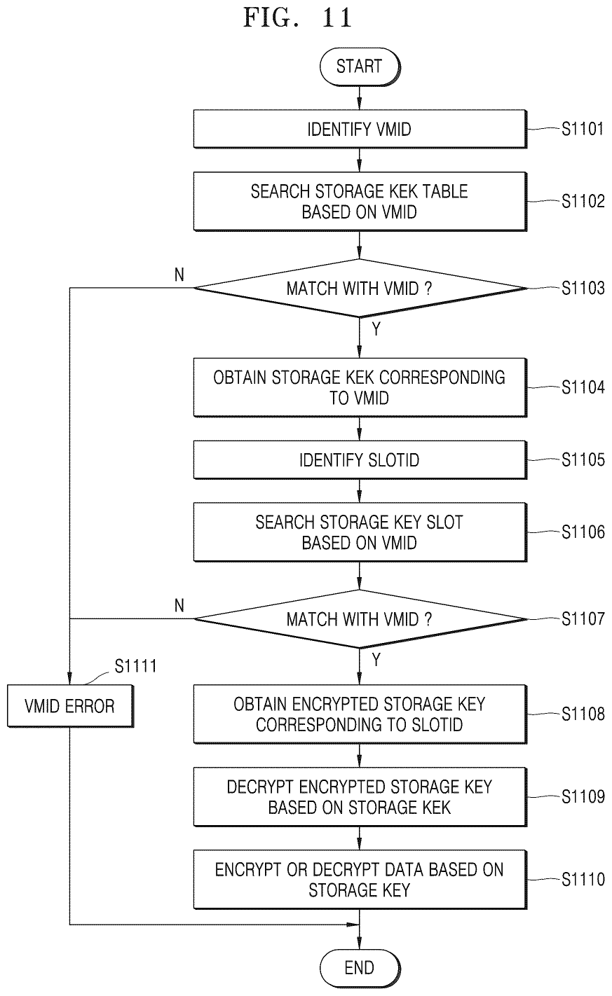

FIG. 11 is a flowchart explaining the operation method of the encryption controller according to an embodiment. FIG. 11 may be described with reference to FIG. 10.

Referring to FIG. 11, in operation S1101, the encryption controller 122 may identify a virtual machine identifier VMID stored in the VMID register 211.

In operation S1102, the encryption controller 122 may search a storage KEK table 232 based on the virtual machine identifier VMID.

When the matching virtual machine identifier VMID exists in the storage KEK table 232 (S1103=Y), in operation S1104, the encryption controller 122 may obtain a storage KEK corresponding to the virtual machine identifier VMID. When there is no matching virtual machine identifier VMID in the storage KEK table 232 (S1103=N), in operation S1111, the encryption controller 122 may generate a VMID error signal.

In operation S1105, the encryption controller 122 may identify the slot ID included in the command CMD stored in the message queue 222.

In operation S1106, the encryption controller 122 may search the storage key slot 231 based on the virtual machine identifier VMID.

In operation S1108, when a matching virtual machine identifier VMID exists in the storage key slot 231 (S1107=Y), the encryption controller 122 may obtain an encrypted storage key corresponding to the slot ID. In operation S1111, when there is no matching virtual machine identifier VMID in the storage key slot 231 (S1107=N), the encryption controller 122 may generate the VMID error signal.

In operation S1109, the encryption controller 122 may decrypt the encrypted storage key based on the storage KEK.

In operation S1110, the encryption controller 122 may encrypt data loaded into the memory 20 based on the storage key or decrypt encrypted data read from the storage device 30.

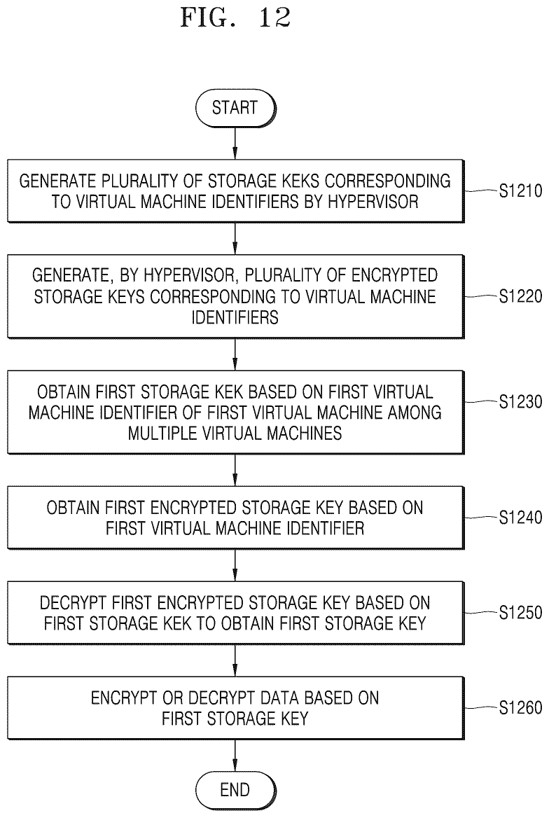

FIG. 12 is a flowchart illustrating a method for controlling access to a storage device in a virtualization environment according to an embodiment.

Referring to FIG. 12, in operation S1210, a hypervisor 40 may generate a plurality of storage KEKs corresponding to virtual machine identifiers through a storage KEK table update operation described above with reference to FIG. 9. Although FIG. 9 describes the guest virtual machine GUEST VM1, the hypervisor 40 may also generate a storage KEK for other virtual machines and update the storage KEK table 232.

In operation S1220, the hypervisor 40 may generate a plurality of encrypted storage keys corresponding to virtual machine identifiers. For example, as described above with reference to FIG. 9, the hypervisor 40 may generate a storage key by decrypting a wrapped key based on a wrapping key and may generate an encrypted storage key by encrypting the storage key based on the storage KEK. The encrypted storage keys may be stored in the encrypted storage key database ENC_KEY DB. The hypervisor 40 may also generate the plurality of encrypted storage keys for a guest virtual machine VM1. Although FIG. 9 describes a guest virtual machine GUEST VM1, the hypervisor 40 may generate at least one encrypted storage key for other virtual machines as well. Further, as described above with reference to FIG. 10, the hypervisor 40 may store an encrypted storage key in the storage key slot 231. The storage key slot 231 may store at least one encrypted storage key for each of a plurality of virtual machine identifiers.

In operation S1230, the encryption controller 122 may obtain a first storage KEK based on the first virtual machine identifier of the first virtual machine among multiple virtual machines. For example, referring to FIG. 10, the encryption controller 122 may obtain a virtual machine identifier VMID from the VMID register 211 and search the storage KEK table 232 based on the virtual machine identifier VMID to obtain the storage KEK.

In operation S1240, the encryption controller 122 may obtain a first encrypted storage key based on the first virtual machine identifier. For example, referring to FIG. 10, the encryption controller 122 may obtain the virtual machine identifier VMID from the VMID register 211, extract a slot ID from a command CMD, and search the storage key slot 231 based on the virtual machine identifier VMID and the slot ID to obtain the encrypted storage key.

In operation S1250, the encryption controller 122 may decrypt the first encrypted storage key based on the first storage KEK to obtain the first storage key.

In operation S1260, the encryption controller 122 may encrypt data in the memory 20 based on the first storage key or decrypt encrypted data read from the storage device 30.

While aspects of embodiments have particularly shown and described, it will be understood that various changes in form and details may be made therein without departing from the spirit and scope of the following claims.

1. A system-on-chip comprising:
a storage host controller comprising a virtual machine identifier register and a buffer, wherein the virtual machine identifier register is configured to store an operating virtual machine identifier of an operating virtual machine that is currently running among a plurality of virtual machines and the buffer is configured to store a command generated by the operating virtual machine; and
a storage encryption controller configured to store a plurality of encrypted storage keys respectively assigned to a plurality of virtual machine identifiers of the plurality of virtual machines, select a first encrypted storage key from among the plurality of encrypted storage keys based on the operating virtual machine identifier stored in the virtual machine identifier register according to the command, and encrypt or decrypt data corresponding to the command based on the first encrypted storage key.

2. The system-on-chip of claim 1, further comprising a protection circuit configured to store information about a storage area assigned to the operating virtual machine identifier of the operating virtual machine, from among a plurality of storage areas of a storage device.

3. The system-on-chip of claim 2, wherein the protection circuit is further configured to delete information about the storage area allocated to the operating virtual machine identifier of the operating virtual machine based on an execution of the operating virtual machine being terminated.

4. The system-on-chip of claim 2, wherein the storage host controller is further configured to provide an address of the storage area, encrypted data, and the command to the storage device.

5. The system-on-chip of claim 2, wherein the storage host controller is further configured to read the data from an address of the storage area according to the command, and provide the read data to the storage encryption controller.

6. The system-on-chip of claim 1, wherein the storage encryption controller further comprises a plurality of storage key encryption keys (KEKs) respectively assigned to the plurality of virtual machine identifiers, and is further configured to select a first storage KEK from among the plurality of storage KEKs based on the operating virtual machine identifier stored in the virtual machine identifier register according to the command, decrypt the first encrypted storage key based on the first storage KEK to obtain a decrypted first storage key, and decrypt or encrypt the data corresponding to the command based on the decrypted first storage key.

7. The system-on-chip of claim 6, wherein the storage encryption controller comprises a memory comprising:
a storage key slot comprising a plurality of key slots respectively storing the plurality of encrypted storage keys corresponding to the plurality of virtual machine identifiers; and
a storage KEK table storing the plurality of storage KEKs corresponding to the plurality of virtual machine identifiers.

8. The system-on-chip of claim 7, wherein the command comprises the operating virtual machine identifier and a key slot identifier, and
wherein the storage encryption controller is further configured to select a first key slot of the plurality of key slots, based on the operating virtual machine identifier and the key slot identifier provided in the command, and select an encrypted storage key stored in the selected key slot as the first encrypted storage key.

9. A method of controlling access to a storage device in a virtualization environment comprising a plurality of virtual machines and a hypervisor, the method comprising:
generating, by the hypervisor, a plurality of storage key encryption keys (KEKs) respectively corresponding to virtual machine identifiers of the plurality of virtual machines;
generating, by the hypervisor, a plurality of encrypted storage keys respectively corresponding to the virtual machine identifiers;
obtaining a first storage KEK from among the plurality of storage KEKs based on a first virtual machine identifier, among the virtual machine identifiers, of a first virtual machine among the plurality of virtual machines;
obtaining a first encrypted storage key from among the plurality of encrypted storage keys based on the first virtual machine identifier;
decrypting the first encrypted storage key based on the first storage KEK to obtain a first storage key; and
encrypting or decrypting data related to a command generated by the first virtual machine based on the first storage key.

10. The method of claim 9, wherein the generating, by the hypervisor, of the plurality of storage KEKs comprises:
generating, by the hypervisor, a second encrypted storage key by encrypting the first storage key, based on a first key; and
storing, by the first virtual machine, the second encrypted storage key.

11. The method of claim 10, wherein the generating, by the hypervisor, of the plurality of storage KEKs comprises:
providing, by the first virtual machine, the second encrypted storage key to the hypervisor;
decrypting, by the hypervisor, the second encrypted storage key, based on the first key to obtain the first storage key;
generating, by the hypervisor, the first encrypted storage key by encrypting the first storage key, based on the first storage KEK corresponding to the first virtual machine identifier among the plurality of storage KEKs; and
storing, by the first virtual machine, the first encrypted storage key in a database.

12. The method of claim 11, wherein the generating, by the hypervisor, of the plurality of storage KEKs further comprises obtaining, by the first virtual machine, a key identifier corresponding to the first encrypted storage key from the database.

13. The method of claim 12, wherein the generating, by the hypervisor, of the plurality of encrypted storage keys further comprises:
obtaining, by the first virtual machine, the first encrypted storage key from the database based on the key identifier; and
storing, by the first virtual machine, the first encrypted storage key in a storage key slot corresponding to the first virtual machine identifier.

14. The method of claim 13, wherein the generating, by the hypervisor, of the plurality of encrypted storage keys further comprises generating, by the first virtual machine, the command based on a slot identifier of the storage key slot.

15. (canceled)

16. The method of claim 9, further comprising:
generating mapping information between the first virtual machine identifier and an address of a storage area of the storage device; and
blocking access to the storage device based on the first virtual machine identifier and an address provided in the command.

17. The method of claim 16, further comprising removing the mapping information between the first virtual machine identifier and the address of the storage area of the storage device based on an execution of the first virtual machine being terminated.

18. An electronic device comprising:
a memory comprising volatile memory cells;
a storage device comprising nonvolatile memory cells; and
a system-on-chip configured to:
store a plurality of encrypted storage keys respectively assigned to a plurality of virtual machine identifiers of a plurality of virtual machines;
store a plurality of storage key encryption keys (KEKs) assigned to the plurality of virtual machine identifiers;
select a first encrypted storage key from among the plurality of encrypted storage keys based on a first virtual machine identifier of a first virtual machine according to a command generated by the first virtual machine from among the plurality of virtual machines;
select a first storage KEK from among the plurality of storage KEKs based on the first virtual machine identifier;
decrypt the first encrypted storage key based on the first storage KEK to obtain a storage key;
read data related to the command from the memory based on the command being a write command, encrypt the read data, based on the storage key; and
store the encrypted data in the storage device.

19. (canceled)

20. The electronic device of claim 18, wherein the system-on-chip comprises a memory comprising:
a storage key slot comprising a plurality of key slots respectively storing the plurality of encrypted storage keys corresponding to the plurality of virtual machine identifiers; and
a storage key encryption key table storing the plurality of storage KEKs respectively corresponding to the plurality of virtual machine identifiers.

21. (canceled)

22. The electronic device of claim 18, wherein the system-on-chip comprises a protection circuit configured to store information about a storage area assigned to the first virtual machine identifier among storage areas of the storage device.

23. The electronic device of claim 22, wherein the protection circuit is further configured to delete information about the storage area allocated to the first virtual machine identifier based on execution of the first virtual machine being terminated.
